(19) United States
(12) Patent Application Publication
(10) Pub. No.: US 2015/0040393 A1
(43) Pub. Date: Feb. 12, 2015

(54) MANUFACTURING METHOD FOR EXHAUST DIFFUSER SHELL WITH STRUT SHIELD COLLAR AND JOINT FLANGE

(71) Applicants: Yevgeniy Shteyman, West Palm Beach, FL (US); Matthew R. Porter, West Palm Beach, FL (US); Mrinal Munshi, Orlando, FL (US); Douglas R. Roth, Oviedo, FL (US); Timothy J. Stewart, Jr., Charlotte, NC (US)

(72) Inventors: Yevgeniy Shteyman, West Palm Beach, FL (US); Matthew R. Porter, West Palm Beach, FL (US); Mrinal Munshi, Orlando, FL (US); Douglas R. Roth, Oviedo, FL (US); Timothy J. Stewart, Jr., Charlotte, NC (US)

(21) Appl. No.: 13/961,186

(22) Filed: Aug. 7, 2013

(51) Int. Cl. B23P 15/00; F01D 25/30

(52) U.S. Cl. CPC B23P 15/00; F01D 25/30
USPC 29/888.02

(57) ABSTRACT

Manufacture of a gas turbine exhaust diffuser shell (40A/40B) to achieve a final cross-sectional shell geometry by forming an opening (76) in the shell to receive a strut shield collar (46); forming a compensating outward bowing (78) of the shell around the opening that departs from a desired final shell geometry in an amount and shape that compensates for a welding shrinkage when welding the collar in the opening; and welding the collar in the opening. This produces the desired shell geometry after the welding. The collar may be welded proximate an edge (74) of the diffuser shell, such as along an intersection of an axial plane with the diffuser shell. A multi-bolt flange (68) may be welded to or otherwise formed along this edge for assembling an annular exhaust diffuser duct (38A-B, 40A/B) in an exhaust section (20) of a gas turbine engine.

### FIELD OF THE INVENTION

The invention relates to manufacturing methods for gas turbine exhaust diffusers, and particularly to welding a structural strut shield collar proximate a bolt joint flange on a diffuser shell without welding distortion of the shell and flange.

### BACKGROUND OF THE INVENTION

A gas turbine (GT) exhaust diffuser is a divergent annular duct lined by inner and outer annular shells through which the exhaust gas passes. The cross-sectional area of the duct progressively increases in the flow direction. This serves to reduce the speed of the exhaust flow and increase its pressure. The exhaust gas may have a temperature of 550-650° C. or more. This causes thermal stresses on components of the exhaust section from operational thermal gradients and cyclic differential expansion fatigue during GT starts and shutdowns. Such stresses are concentrated at interconnections between structures due to differential thermal expansion.

A circular array of struts span between the aft hub of the turbine shaft and the surrounding outer cylinder of the exhaust section. Each strut is surrounded by a tubular heat shield connected between the inner and outer diffuser shells, which fixes the two shells together to form the diffuser annular duct assembly. A collar at each end of each shield tube is welded to the respective inner/outer diffuser shell.

### BRIEF DESCRIPTION OF THE DRAWINGS

The invention is explained in the following description in view of the drawings that show:

FIG. 1 is an axial sectional view of an exhaust section of a gas turbine taken along line 1-1 of FIG. 2.

FIG. 2 is a partial transverse sectional view of the exhaust section taken along line 2-2 of FIG. 1.

FIG. 3 is a partial perspective view of an upper half of the exhaust diffuser duct assembly of FIG. 2, with inner and outer arcuate shells and a bolt joint flange.

FIG. 4 is a sectional view taken on line 4-4 of FIG. 3 in a plane transverse to the diffuser axis.

FIG. 5 is a surface view of the outer diffuser shell taken along view line 5-5 of FIG. 4.

### DETAILED DESCRIPTION OF THE INVENTION

The present inventors have determined that, in some gas turbine engine exhaust configurations, one of the collars at the ends of the shield tubes may be relatively near a bolting flange that connects upper and lower halves of the shell, and that in such configurations, the collar welding process tends to warp the shell. The inventors have determined that welding shrinkage bows the shell radially inward, which misaligns the bolting flange relative to the opposed flange on the other half of the shell, and that this phenomenon to be less evident and less problematic when the collar is located away from the bolting flange. A novel method of manufacturing such components is disclosed herein to address this previously unidentified problem.

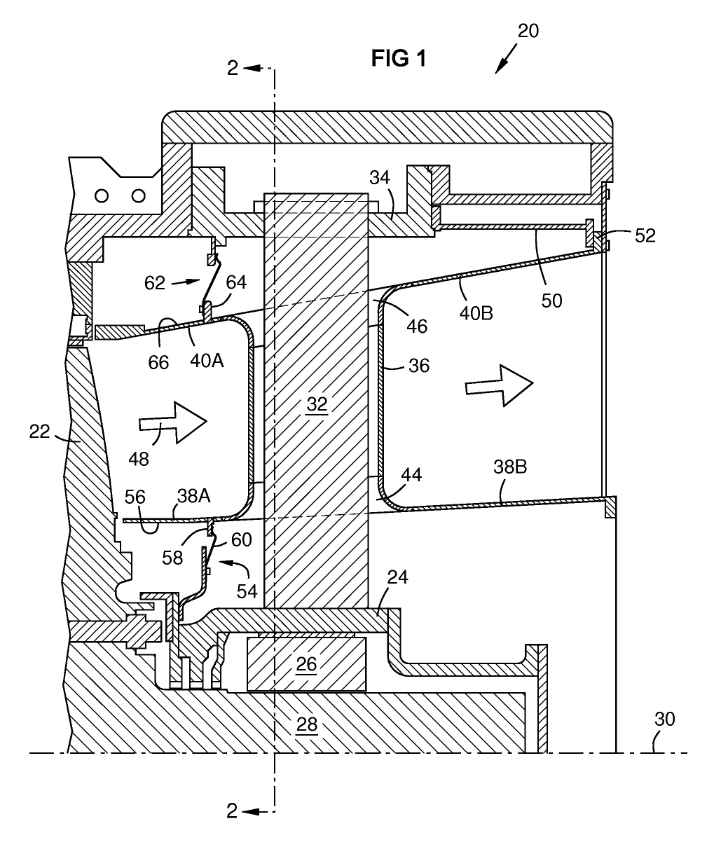

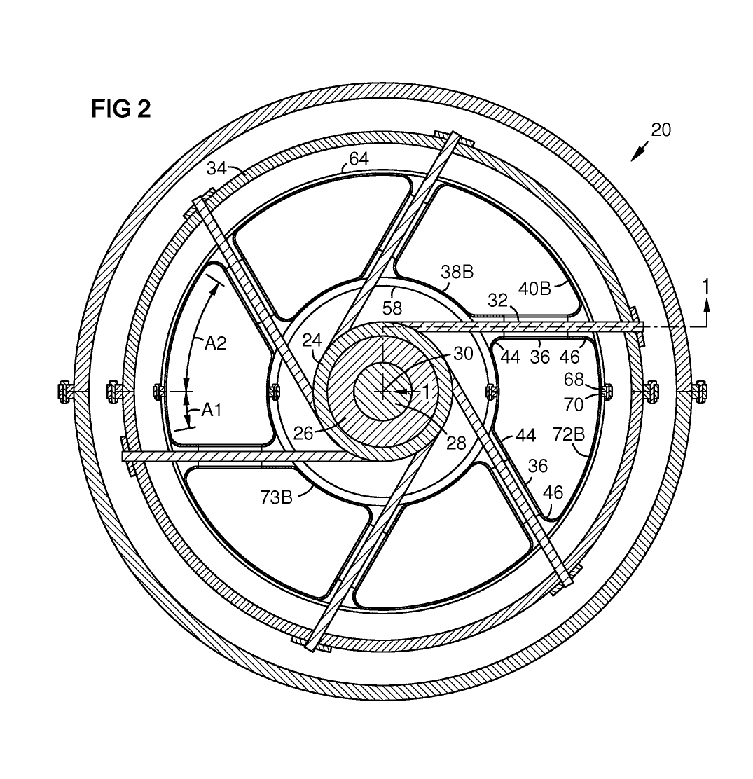

FIG. 1 illustrates an upper half of an exhaust section 20 of a gas turbine engine behind a last row of rotating blades 22. A hub 24 may extend into the exhaust section and enclose an aft bearing 26 that supports the turbine shaft 28 for rotation about an axis 30. A divergent annular flow path for exhaust gas 48 is defined between an inner diffuser shell 38A-B and an outer diffuser shell 40A-B, where “A” and “B” designate respective forward and aft portions of the shells. The turbine axis 30 may also be a geometric axis of the diffuser shells. A circular array of struts 32 spans between the hub and an outer cylinder 34. For conceptual clarity, FIG. 1 appears as though the struts are oriented radially. However, they may be oriented tangentially to the hub as shown in FIG. 2.

Each strut may be surrounded by a tubular heat shield 36 connected between the inner and outer diffuser shells. An inner collar 44 and an outer collar 46 may be provided at the ends of each shield 36 to attach the shield to the respective diffuser shell. The shields/collars fix the shells to each other, thus forming a diffuser duct assembly 36, 38A-B, 40A-B, 44, 46. An annular diffuser support structure 50 is attached to the outer cylinder 34. The diffuser support structure 50 may take the form of a ring or a circular array of adjacent plates. The aft portion of the outer diffuser shell 40B is attached to this support structure by an outer diffuser aft flange 52.

A forward inner seal 54 may be provided around a radially inner surface 56 of the inner diffuser shell 38A-B to separate areas of different gas temperatures and/or pressures. This seal may include an annular inner flange 58 welded to the shell 38A-B.

It may further include a flexible annular seal member 60 that maintains sealing contact with the flange 58. A similar forward outer seal 62 with an annular outer flange 64 may be provided around a radially outer surface 66 of the outer diffuser shell 40A-B.

FIG. 2 is a transverse sectional view of the GT exhaust section 20 of FIG. 1. A hub 24 encloses an aft bearing 26 that supports the turbine shaft 28 for rotation about an axis 30. A circular array of struts 32 connects the hub to the outer cylinder 34 for mutual support. The struts may be oriented tangentially to the hub as shown to accommodate differential thermal expansion between the hub, struts, and outer cylinder. Each strut is surrounded by a heat shield 36 connected between the inner shell 38B and the outer shell 40B. An inner collar 44 and an outer 46 collar may be used to attach each heat shield to a respective diffuser shell. The diffuser shells and other major annular components of the exhaust section 20 are often made in upper and lower halves that are joined at bolt flanges, such as an upper multi-bolt flange 68 and a mating lower multi-bolt flange 70 as indicated on the outer diffuser shell 40B.

In the configuration of FIG. 2, the collar 46 nearest the joint 68/70 on the upper half of the outer diffuser shell 40B may be relatively close to the joint 68/70. Furthermore it may be closer to the joint than the nearest collar 46 on the lower half 72B of the outer diffuser shell. Welding shrinkage of the shell around these collars causes misalignment of the flanges 68, 70. The angular distances of the two nearest collars to a shell joint are indicated on the left side of the drawing. In this configuration, angle A1 may be less than 20 degrees or especially less than 15 degrees, while angle A2 may be greater than 25 degrees for example. The invention is described below with respect to the collar 46 nearest joint 68/70, but it is recognized that it may be applied at any such joint where distortion due to welding is a concern, for example at diametrically opposed joints in the respective upper and lower segments of a particular diffuser shell. Each shell 38B, 40B, 72B, 73B is shown in a final cross-sectional geometry, which may follow a circular arc about the diffuser axis 30. Each upper/lower shell for example may follow an arc of 180 degrees.

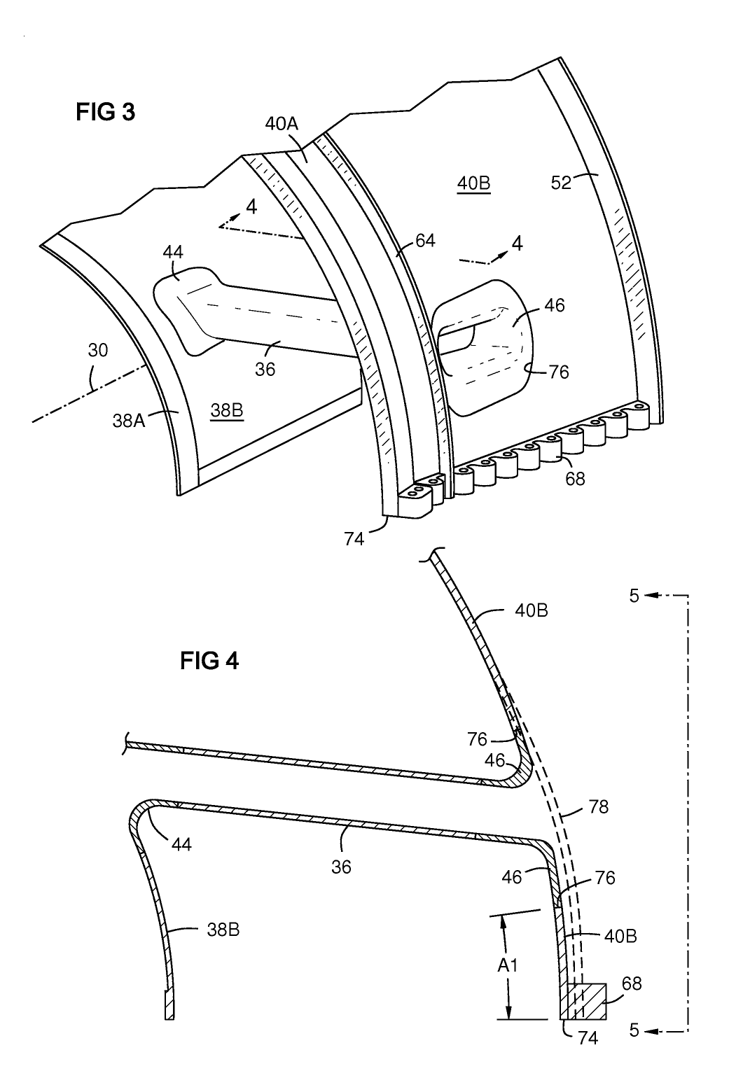

FIG. 3 is a partial perspective view of an upper half of the inner and outer shells 38B, 40B interconnected with a strut shield 36 and collars 44, 46. A multi-bolt joint flange 68 is attached along an edge 74 of the outer shell 40A/40B. The outer shell may be formed of metal with a cross sectional shape that is circular about the diffuser axis 30. The edge 74 may be along an intersection of an axial plane with the shell, such as along the horizontal plane through a horizontal axis 30, or along another line. An opening 76 may be formed in the shell for a strut shield collar 46, to be welded therein.

FIG. 4 is a cross-sectional view taken on line 4-4 of FIG. 3 in a plane normal to the diffuser axis 30. In order to compensate for inward distortion of the shell 40B during welding the collar 46 to the shell, the shell is formed with an outward bow 78 around the opening 76 in an amount that compensates for the welding shrinkage. “Outward bow” means the shell departs outwardly or distally from a desired final cross-section geometry. In FIG. 4 the desired geometry is shown in solid lines and the outward bow 78 is shown in hatched lines. For example, without being limiting, the outwardly bowed portion 78 may have a maximum radius of 2010 mm compared to a radius of 2000 mm in the final cross-section geometry of the shell 40B, thus giving it an outward bow amount of 10 mm or 0.5% of the radius. This percentage depends on materials, shell thickness, welding method, diffuser/collar size, proximity of the collar 46 to the edge 74, and other design factors. The percentage may be in a range from 0.2%-0.9% and especially 0.3%-0.8% in some embodiments. The amount of the outward bow is also responsive to the stiffness provided to the shell 40B by the flange 68, since the flange is typically welding onto the shell before the collar weld is made. Different designs for flange 68 may exhibit different amounts of axial bending stiffness; therefore the flange design is a variable that is considered when calculating an amount of outward bow for any particular diffuser design.

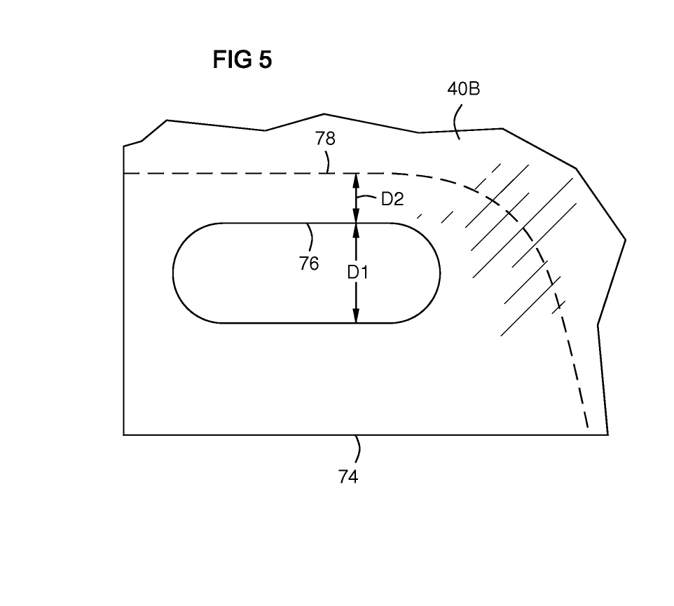

The outward bowing 78 compensates for the welding shrinkage, meaning that it neutralizes the bowing caused by the welding, e.g. it counteracts the welding bowing to within a tolerance desired for alignment of the flange 68. This means the outward bowing facilitates achieving the final desired cross-sectional shell geometry after welding of the collar 46 into the opening 76, and it maintains a final post-weld position of the flange 68 to within an acceptable tolerance of a design position. The outward bowing may produce a final cross-sectional shell geometry that follows a circular arc after welding of the collar 46 into the opening 76. FIG. 5 shows a surface view of the outer diffuser shell from the viewpoint of line 5-5 of FIG. 4. The compensating bowing 78 may be started for example within an upper border D2 of less than the circumferential dimension D1 of the hole 76, and may extend downward to the shell edge 74 on the opposite side of the hole. Alternately, the shape of the compensating outward bowing 78 may be the reverse or mirror image across the final shell geometry of the inward bowing caused by the welding shrinkage.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method for manufacturing a gas turbine exhaust diffuser, the method comprising:
forming a metal diffuser shell with a cross-sectional shell geometry;
forming an opening in the diffuser shell to receive a strut shield collar;
forming a compensating outward bowing of the diffuser shell geometry around the opening that departs from a final cross-sectional shell geometry in an amount that compensates for a welding shrinkage when welding the collar in the opening, thus producing the final shell geometry after the welding; and
welding the collar in the opening.

2. The method of claim 1, further comprising welding a multi-bolt joint flange along an edge of the diffuser shell proximate the collar prior to welding the collar.

3. The method of claim 1, further comprising:
forming the diffuser shell wherein the final cross-sectional geometry follows an arc about a diffuser axis, and comprises an edge along an intersection of an axial plane and the shell;
welding a multi-bolt flange along an edge of the shell; and
welding the collar within 20 degrees of the edge along the arc.

4. The method of claim 1, further comprising:
forming the diffuser shell in a cross-sectional geometry that follows an arc about a diffuser axis; and
forming the compensating bowing within a border of less than a circumferential dimension of the opening on one side of the opening and extending to a shell edge on an opposite side of the opening;
wherein the shell edge follows an intersection of an axial plane and the shell.

5. The method of claim 1, further comprising forming the compensating bowing as a reversal of an inward bowing of the shell caused by the welding shrinkage.

6. The method of claim 1, further comprising:
forming the diffuser shell in a cross-sectional geometry that follows a circular arc about a diffuser axis; and
forming the compensating outward bowing to depart from the final cross-sectional geometry by 0.2-0.9% of a radius of the circular arc.

7. A method for manufacturing a gas turbine exhaust diffuser, the method comprising:
forming a diffuser shell segment with an arc shaped cross-section terminating in an edge and comprising an opening;
welding a strut shield collar within the opening; and
forming an outward bowing of the diffuser shell segment cross-section proximate the opening prior to the welding step to at least partially compensate for an anticipated inward bowing induced by welding shrinkage during the welding step.

8. The method of claim 7, further comprising:
welding a multi-bolt flange along the edge; and
forming the outward bowing in an amount effective to maintain a final position of the flange after the welding steps to within a desired tolerance from a design position.

9. The method of claim 8, further comprising:
forming the diffuser shell segment to have a cross-section that follows a circular arc about a diffuser axis; and
forming the outward bowing to depart from the circular arc by 0.2-0.9% of a radius of the circular arc.

10. The method of claim 7, further comprising forming the outward bowing within a border extending from the edge on one side of the opening to beyond the opening on an opposite side of the opening.

11. A method for manufacturing a gas turbine exhaust diffuser, the method comprising:
forming a diffuser shell of metal with a cross-sectional shell geometry that follows a circular arc about an axis of the diffuser;
forming an opening in the diffuser shell to receive a strut shield collar;
forming a compensating outward bowing of the diffuser shell around the opening, wherein the bowing departs from a desired final cross-sectional shell geometry in a shape and amount that neutralizes an inward bowing caused by a welding shrinkage when welding the collar in the opening, thus producing the desired final shell geometry after the welding; and
welding the collar in the opening.

12. The method of claim 11, further comprising:
welding a multi-bolt joint flange along an edge of the diffuser shell that follows an intersection of an axial plane and the diffuser shell; and
forming the outward bowing in a geometry effective to maintain a final position of the flange after the collar welding step to within a desired tolerance from a design position.

13. The method of claim 11, further comprising:
welding the collar to within 15 degrees of an edge of the diffuser shell that follows an intersection of an axial plane with the diffuser shell;
welding a multi-bolt flange along the edge of the diffuser shell; and
forming the compensating outward bowing so that it departs from the desired final cross-sectional geometry in the amount of 0.3-0.8% of a radius of the circular arc.

14. The method of claim 11, further comprising forming the compensating outward bowing within a border of less than a circumferential dimension of the opening on one side of the opening and extending to an edge of the shell on the opposite side of the opening.

15. The method of claim 11, further comprising forming the compensating bowing as a mirror image across the final geometry of the shell of an inward bowing caused by the welding shrinkage.
